(19) United States
(12) Patent Application Publication
(10) Pub. No.: US 2009/0228786 A1
(43) Pub. Date: Sep. 10, 2009

(54) FLEXIBLE CREATION OF AUTO-LAYOUT COMPLIANT DIAGRAMS

(75) Inventors: Stephen M. Danton, Seattle, WA (US); Scott Roberts, Bothell, WA (US); Laurent Mollicone, Kirkland, WA (US); Florian Voss, Seattle, WA (US); Kean EE Lim, Issaquah, WA (US); Yuri Rychikhin, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/045,517

(22) Filed: Mar. 10, 2008

(51) Int. Cl. G06F 17/00

(52) U.S. Cl. 715/243

(57) ABSTRACT

The present invention extends to methods, systems, and computer program products for flexible creation of auto-layout compliant diagrams. Visual feedback is provided to a user to assist the user with adding, deleting, and moving visual elements in diagrams in compliance with auto-layout constraints. Visual feedback is provided prior to adding, deleting, and moving a visual element so a user has an indication of what diagram's layout is to be after adding, deleting, or moving the visual element. Visual feedback can include shape guides that correspond to auto-layout compliant locations where a visual element can be added to a diagram. Accordingly, embodiments of the invention provide a user experience that approaches the flexibility of free form editing but retains the benefits of auto-layout mechanisms.

### CROSS-REFERENCE TO RELATED APPLICATIONS

Not Applicable.

### BACKGROUND

1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many business related processes are distributed across a number of different computer systems and/or a number of different computing components.

For example, diagramming applications can be used to generate flow charts, organization charts, workflow diagrams, etc. Most diagramming applications include at least a toolbar and a canvas area. A user can pull shapes (e.g., circles, rectangles, squares, diamonds, etc.) from the tool bar to add to the canvas. Shapes can be connected to one another to indicate relationships between the shapes. Users can also rearrange and remove existing shapes and connections within the canvas.

At least some diagramming applications utilize a free form canvas allowing the user complete control over the organization and spacing of shapes on a canvas. Users are free to (re)arrange shapes and connections as they see fit with no restrictions. Thus, free form canvases give a user significant flexibility to create diagrams to their exact specifications.

However, creating diagrams using a free from canvas can also be tedious and labor intensive. The meaning of a diagram is more appropriately conveyed (e.g., visually perceived) when shapes within a diagram are organized and appropriately spaced. Thus, each time a diagram changes (e.g., a new shape is introduced into or an existing shaped is removed from or moved within a diagram), the organization and spacing of shapes and connections may need to be adjusted to appropriately convey the new meaning of the diagram.

Unfortunately, using a free form canvas, a user is required to individually make all these adjustments, such as, for example, disconnecting and reconnecting shapes, pixel alignment, etc., on their own. For many diagrams, and especially larger and/or more complex diagrams, these adjustments can be numerous and can take a considerable amount of time to implement. Further, a single change to a diagram can have a ripple effect causing a large number shapes to become unorganized and or inappropriately spaced.

Accordingly, some diagramming applications include automated mechanisms, such as, for example, an auto-layout algorithm, to assist users in appropriately adjusting shapes and connections in response changes to a diagram. An auto-layout algorithm can have various layout (e.g., organizational and spacing) constraints that essentially dictate the placement of shapes and connections within a diagram. An auto-layout algorithm can also include one or more of a variety of different functions.

For example, when a shape (either new or moved) is inserted into a specified location within a diagram, an auto-layout algorithm can automatically move the shape from the specified location to a more appropriate (e.g., close by) location (on a canvas) to comply with layout constraints. Similarly, when a shape is removed (either deleted or moved) from a location within a diagram, the auto-layout algorithm can automatically adjust shapes previously connected to the removed shape (on the canvas) to comply with layout constraints. When a shape is moved within a diagram, both of these functionalities can be implemented. Auto-layout algorithms can also include the functionality to adjust any and other shapes and connections within a diagram in response to adding, deleting, or moving a shape to comply with layout constraints (e.g., to compensate for ripple effects).

Accordingly, auto-layout algorithms can be utilized to automatically arrange shapes and connections within a diagram to better convey the new meaning of the diagram. Some auto-layout algorithms even permit the tuning of layout constraints so that a user has some control of the layout of a diagram. However, auto-layout algorithms are typically prescriptive and do not permit non-compliant changes (even based on tuned layout constraints) to a diagram. Further, a user typical has no way to know before inserting, moving, or deleting a shape, how the auto-layout algorithm will adjust the location of the shape and/or surrounding connected shapes.

Often, a shape can be placed at any number of locations relative to existing shapes of a diagram and comply with layout constraints. However, the user may have no way to know before making a change what the compliant locations are relative to the existing shape. Thus, a user must rely on the auto-layout algorithm to select a compliant location, which based on the user's intent for a diagram, may not be the most appropriate compliant location.

### BRIEF SUMMARY

The present invention extends to methods, systems, and computer program products for flexible creation of auto-layout compliant diagrams. In some embodiments, a visual element is included at a location within a diagram. For example, a computer system presents an arrangement of a plurality of interconnected visual elements representing a diagram. The arrangement is presented in compliance with an auto-layout algorithm. The computer system receives input selecting a visual element for placement in the arrangement of the plurality of interconnected visual elements. The computer system provides element selection visual feedback indicating that the selected visual element is selected.

The computer system detects the presence of the selected visual element at a location relative to the arrangement of the plurality of interconnected visual elements. Prior to placement of the selected visual element, the computer system provides discrete location visual feedback indicating a set of possible discrete locations where the selected visual element can be placed in the arrangement of the plurality of interconnected visual elements. Each discrete location in the set of possible discrete locations complies with the constraints of the auto-layout algorithm. The discrete location visual feedback is provided in response to selection of the selected visual element and based on detecting the presence of the selected visual element at the relative location.

The computer system receives input selecting a corresponding discrete location, from among the set of possible discrete locations, for placement of the selected visual element. The computer system automatically updates the arrangement of the plurality of interconnected visual elements in response to selection of the selected corresponding discrete location and in compliance with the constraints of the auto-layout algorithm. Updating the arrangement includes inserting the selected visual element into the arrangement of the plurality of visual elements at the selected corresponding discrete location. Updating also includes connecting the selected visual element to one or more other visual elements in the arrangement of the plurality of interconnected visual elements. The computer system presents the updated arrangement of the plurality of interconnected visual elements in compliance with the constraints of the auto-layout algorithm so as to reflect the addition of the selected visual element to the diagram.

In other embodiments, a visual element is removed from a diagram. For example, a computer system presents an arrangement of a plurality of interconnected visual elements representing a diagram. The arrangement is presented in compliance with an auto-layout algorithm. The computer system receives selection input selecting a visual element for removal from the arrangement of the plurality of interconnected visual elements.

The computer system provides visual feedback indicating that the selected visual element and connections between the selected visual element and one or more other visual elements are selected in response to the selection input. The computer system receives removal input indicating that the selected visual element is to be removed from the arrangement of the plurality of interconnected visual elements subsequent to receiving input selecting the selected visual element.

The computer system automatically updates the arrangement of the plurality of interconnected visual elements in response to removal input and in compliance with the constraints of the auto-layout algorithm. Updating the arrangement includes removing the selected visual element from the arrangement of the plurality of interconnected visual elements. Update the arrangement also includes removing the selected connections between the selected element and the one or more other visual elements. The computer system presents the updated arrangement of the plurality of interconnected visual elements in compliance with the constraints of the auto-layout algorithm so as to reflect removal of the selected visual element from the diagram.

Moving an element within a diagram can include adding the element in one location of the diagram and removing the element from another different location in the diagram.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates flexible creation of auto-layout compliant diagrams.

FIG. 2 illustrates a flow chart of an example method for flexibly integrating a shape into an auto-layout compliant diagram.

FIGS. 3A-3D illustrate an example of flexibly integrating a shape into an auto-layout compliant diagram.

FIGS. 4A-4C illustrate another example of flexibly integrating shape into an auto-layout compliant diagram.

FIGS. 5A-5C illustrate another example of flexibly integrating a plurality of shapes into an auto-layout compliant diagram.

FIGS. 6A-6D illustrate an example of flexibly reordering shapes in an auto-layout compliant diagram.

FIG. 6E illustrates a shape guide having a plurality of selectable behaviors.

FIGS. 7A and 7B illustrate shifting a shape within an auto-layout compliant diagram.

FIGS. 8A-8C illustrate snapping a shape within an auto-layout compliant diagram.

FIG. 9 illustrates shape guides for a decision pattern for an auto-layout compliant diagram.

FIG. 10 illustrates shape guides for a radial pattern for an auto-layout compliant diagram.

FIG. 11 illustrates shape guides for an error for an auto-layout compliant diagram.

FIG. 12 illustrates freeform shape guide for a diagram.

FIGS. 13A and 13B illustrate an example of flexibly integrating a shape into an auto-layout compliant diagram between other existing shapes.

FIG. 14 illustrates a flow chart of an example method for flexibly integrating a shape into an auto-layout compliant diagram.

FIGS. 15A-15C illustrate examples of flexibly removing a shape from an auto-layout compliant diagram.

### DETAILED DESCRIPTION

The present invention extends to methods, systems, and computer program products for flexible creation of auto-layout compliant diagrams. A computer system presents an arrangement of a plurality of interconnected visual elements representing a diagram. The arrangement is presented in compliance with an auto-layout algorithm. The computer system receives input selecting a visual element for placement in the arrangement of the plurality of interconnected visual elements. The computer system provides element selection visual feedback indicating that the selected visual element is selected.

The computer system detects the presence of the selected visual element at a location relative to the arrangement of the plurality of interconnected visual elements. Prior to placement of the selected visual element, the computer system provides discrete location visual feedback indicating a set of possible discrete locations where the selected visual element can be placed in the arrangement of the plurality of interconnected visual elements. Each discrete location in the set of possible discrete locations complies with the constraints of the auto-layout algorithm. The discrete location visual feedback is provided in response to selection of the selected visual element and based on detecting the presence of the selected visual element at the relative location.

The computer system receives input selecting a corresponding discrete location, from among the set of possible discrete locations, for placement of the selected visual element. The computer system automatically updates the arrangement of the plurality of interconnected visual elements in response to selection of the selected corresponding discrete location and in compliance with the constraints of the auto-layout algorithm. Updating the arrangement includes inserting the selected visual element into the arrangement of the plurality of visual elements at the selected corresponding discrete location. Updating also includes connecting the selected visual element to one or more other visual elements in the arrangement of the plurality of interconnected visual elements. The computer system presents the updated arrangement of the plurality of interconnected visual elements in compliance with the constraints of the auto-layout algorithm so as to reflect the addition of the selected visual element to the diagram.

In other embodiments, a visual element is removed form a diagram. For example, a computer system presents an arrangement of a plurality of interconnected visual elements representing a diagram. The arrangement is presented in compliance with an auto-layout algorithm. The computer system receives selection input selecting a selected visual element for removal form the arrangement of the plurality of interconnected visual elements.

The computer system provides visual feedback indicating that the selected visual element and connections between the selected visual element and one or more other visual elements are selected in response to the selection input. The computer system receives removal input indicating that the selected visual element is to be removed from the arrangement of the plurality of interconnected visual elements subsequent to receiving input selecting the selected visual element.

The computer system automatically updates the arrangement of the plurality of interconnected visual elements in response to removal input and in compliance with the constraints of the auto-layout algorithm. Updating the arrangement includes removing the selected visual element from the arrangement of the plurality of interconnected visual elements. Update the arrangement also includes removing the selected connections between the selected element and the one or more other visual elements. The computer system presents the updated arrangement of the plurality of interconnected visual elements in compliance with the constraints of the auto-layout algorithm so as to reflect removal of the selected visual element from the diagram.

Moving an element within a diagram can include adding the element in one location of the diagram and removing the element from another different location in the diagram.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, it should be understood, that upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

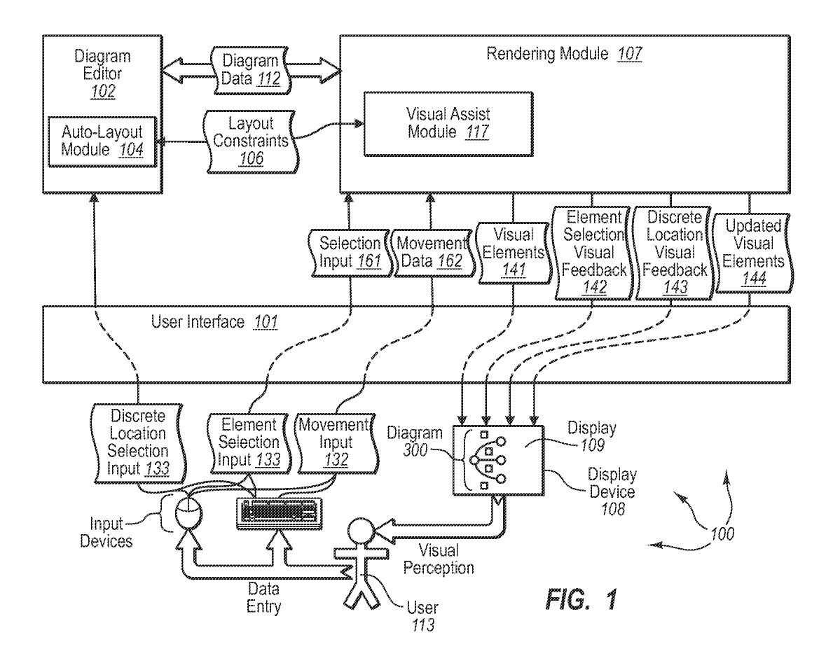

FIG. 1 illustrates an example computer architecture 100 that facilitates flexible creation of auto-layout compliant diagrams. Referring to FIG. 1, computer architecture 100 includes user-interface 101, diagram editor 102, and rendering module 103. Each of the depicted components can be connected to one another over (or be part of) a network, such as, for example, a Local Area Network (“LAN”), a Wide Area Network (“WAN”), and even the Internet. Accordingly, each of the depicted components as well as any other connected components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Input devices 112 can include a variety of input devices, such as, for example, a keyboard and/or mouse. User 113 can utilize input devices 112 to enter data into computer architecture 112. Display device 108 can visually present data output from computer architecture 101 on display 109. User 113 can visually perceive data displayed at display 109.

Generally, user-interface is configured to function as an intermediary software layer between user 113 and the other components of software architecture 100. User-interface 101 can be configured with appropriate software, such as, for example, drivers, to receive input from input devices 112 and to send output to display device 180. Thus, user-interface 101 can forward user-input to other components, such as, for example, diagram editor 102. User-interface 101 can also forward renderable image data from other components, such as, for example, rendering module 103, to display device 108.

Diagram editor 102 is configured to edit diagram data for renderable diagrams. Diagram data can indicate shape types, shape locations, and connections between shapes for visual elements in a diagram. In response to user-input, diagram editor 102 can add, delete, and alter diagram data representing shapes location, shape types, and connections for visual elements of a diagram. In some embodiments, a user action causes diagram editor 112 to perform a series of edits to diagram data. For example, in response to placement of a visual element in a diagram, diagram editor 112 can a) edit diagram data to include the location and type of a shape for the visual element and b) edit diagram data to include connections between the shape and other appropriate shapes.

As depicted, diagram, editor 102 includes auto-layout module 104. Auto-layout module 104 is configured to insure that the layout of visual elements in a diagram complies with layout constraints 106. Layout constraints 106 can constrain various layout characteristics of visual elements, such as, for example, organization, spacing, etc., for a diagram. Thus, upon receiving user-input indicating a change to diagram data, auto-layout module 104 can determine if a resulting layout of visual complies with layout constraints 106. If not, auto-layout module 104 can implement further automated changes to cause the layout of visual elements for a diagram to comply with layout constraints 106.

Rendering module 103 is configured to generate interconnected visual elements from diagram data for rendering a diagram at display device 108. Diagrams be any of a variety of different types of diagrams includes flow charts, workflow diagrams, organizational charts, process diagrams, schematics, etc. Diagrams can include any of a variety of different visual elements including geometric shapes, such as, for example, circles, diamonds, squares, rectangles, triangles, etc. Connections between visual elements can be represented as a line.

As depicted, rendering module 103 includes visual assist module 117. Visual assist module 117 is configured to provide visual feedback to a user to assist the user with diagram creation and editing. For example, upon user selection of a visual element in a diagram, visual assist module 117 can provide visual feedback indicating selection of the visual element. Prior to placement of a selected visual element, visual assist module 117 can also provide visual feedback indicating one or more discrete locations where placement of the selected visual element would comply with layout constraints 106. Visual feedback can include altering visual characteristics of elements and connections to indicate selection. Visual feedback can also include supplementing a diagram with additional visual information to assist a user in the layout of elements and connections with in a diagram.

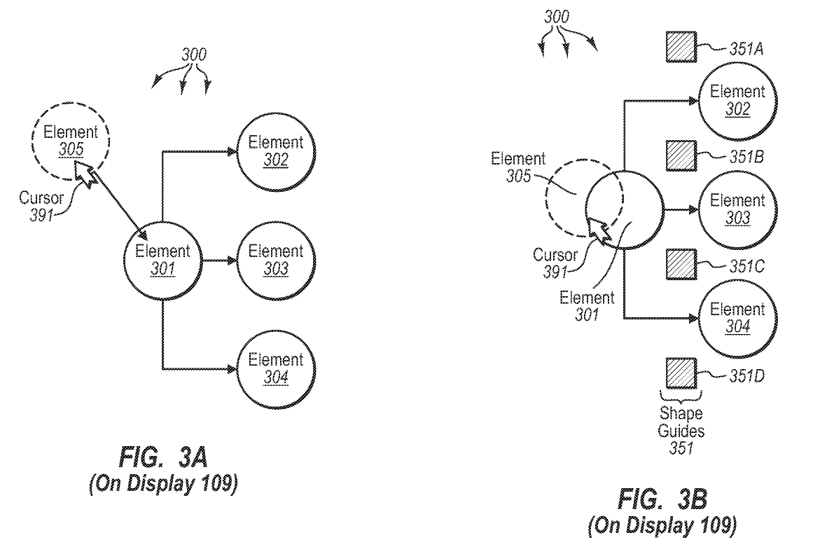

FIGS. 3A-3D illustrate flexibly integrating a shape into auto-layout compliant diagram 300.

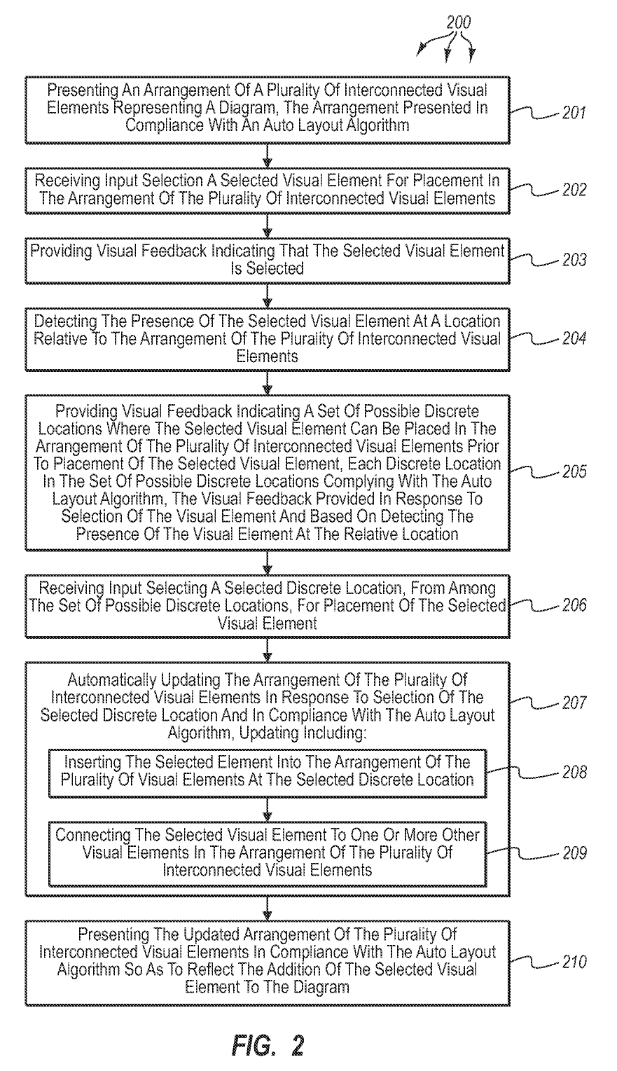

FIG. 2 illustrates a flow chart of a method 200 for flexibly integrating a shape into an auto-layout compliant diagram. Method 200 will be described with respect to the components and data depicted in computer architecture 100 and with respect to auto-layout compliant diagram 300.

Method 200 includes in act of presenting an arrangement of a plurality of interconnected visual elements representing a diagram, the arrangement presented in compliance with constraints of an auto-layout algorithm (act 201). For example, user-interface 101 can present visual elements 141 at display device 108. Visual elements 141 can be presented in compliance with layout constraints 106 as enforced by auto-layout module 104. For example, referring to FIG. 3A, elements 301, 302, 303, and 304 and corresponding connections of diagram 300 can be presented on display 109.

Method 200 includes an act of receiving input selecting a selected visual element for placement in the arrangement of the plurality of interconnected visual elements (act 202). For example, user-interface 101 can receive user-element selection input 133. User-interface 101 can determine that user-element selection input 133 is the selection of a new or existing visual element. As such, user-interface 101 can forward user input 161 to rendering module 107.

A new element (e.g., from a toolbar) can be selected for inclusion in a diagram. An existing element (e.g., already in the diagram) can be selected for moving within the diagram. For example, referring to FIG. 3A, element 305 (a new element or an element from elsewhere in diagram 300) can be selected for inclusion into or movement within diagram 300. When an existing element is selected for movement, a current representation of the existing element can remain in its current location. Along with the current representation, a selected temporary representation of the existing element can be created. The selected temporary representation of the element can be moved within a diagram to represent possible movement of the element to different locations in the diagram. If actual movement of the existing element eventually results, the current representation of the element is moved to the new location.

Method 200 includes an act of providing element selection visual feedback indicating that the selected visual element is selected (act 203). For example, visual assist module 117 can provide element selection visual feedback 142 for display at display device 108. Element selection visual feedback can result from altering the visual characteristics of a selected visual element in some way to indicate that it is selected. For example, referring again to FIG. 3A, user 113 has selected element 305 with cursor 391. As depicted, element 305 is represented with a dashed line (as opposed to a solid line) to indicate that element 305 is selected. However, other visual characteristics changes, such as, for example, changes to color, brightness, size, shape, etc. are also possible. Visual perception of the dashed line (or other visual characteristic) permits user 113 to more easily determine that element 305 is selected. If element 305 is an existing element, a current representation of element 305 can remain elsewhere (not shown) in diagram 300.

Method 200 includes an act of detecting the presence of the selected visual element at a location relative to the arrangement of the plurality of interconnected visual elements (act 204). For example, referring to both FIGS. 1 and 3B, user-interface 101 can detect movement input 132 indicating that element 305 has moved so that it is at least partially co-located with element 301 (e.g., on display 109). User-interface 101 can determine that movement input 132 is relevant to rendering module 107 and can forward movement data 162 to rendering module 107. Rendering module 107 can determine from movement data 162 that element 305 is at least partially co-located element 301.

Method 200 includes an act of providing discrete location visual feedback indicating a set of possible corresponding discrete locations where the selected visual element can be placed in the arrangement of the plurality of interconnected visual elements prior to placement of the selected visual element, each corresponding discrete location in the set of possible discrete locations complying with the constraints of the auto-layout algorithm, the visual feedback provided in response to selection of the selected visual element and based on detecting the presence of the selected visual element at the relative location (act 205). For example, still referring to both FIGS. 1 and 3B, visual assist module 117 can provide discrete location visual feedback 143 for display at display device 108. Discrete location visual feedback 143 can include shape guides 351. Shape guides 351 are provided in response to the selection of element 305 and based on detecting that element 305 is at least partially co-located with element 301.

Shape guides 351 includes shape guides 351A, 351B, 351C, and 351D. Each of shape guides 351A, 351B, 351C, and 351D represent (although are not necessarily precisely at) a corresponding discrete location where element 305 can be placed for connection to element 301. Shape guides 351 are located based on the position of element 301 relative to elements 302, 303, and 304. Further, the corresponding discrete location corresponding to each of shape guides 351A, 351B, 351C, and 351D complies with layout constraints 106. Visual perception of shape guides 351 permits user 113 to more easily determine what the resulting position of element 305 is to be prior to actually placing element 305 in diagram 300.

As depicted in FIG. 3C, subsequent to presentation of shape guides 352, user 111 can further manipulate input devices 112 to move element 305 so that it is at least partially co-located with shape guide 351 C. Manipulation of input devices 112 can cause further movement input that is forwarded to rendering module 107 as movement data. Based on the movement data, rendering module 107 can reflect the movement of element 305 and that element 305 is at least partially co-located with shape guide 351C (e.g., on display 109).

Method 200 includes an act of receiving input selecting a selected corresponding discrete location, from among the set of possible discrete locations, for placement of the selected visual element (act 206). For example, referring to FIGS. 1 and 3C, user-interface 101 can receive discrete location selection input 133 for placement of element 305. Discrete location selection input 133 can result from the release (or activation) of a mouse button (or other input control) while element 305 is at least partially co-located with shape guide 351 A. Discrete location selection input 133 essentially indicates to diagram editor 102 that user 113 has selected the discrete location corresponding to (although no necessary precisely at) shape guide 351C for placement of element 305. For example, using a mouse, a user can “drop” element 305 onto shape guide 351C to select the discrete location corresponding to shape guide 351C

Method 200 includes an act of automatically updating the arrangement of the plurality of interconnected visual elements in response to selection of the selected corresponding discrete location and in compliance with the constraints of the auto-layout algorithm (act 207). For example, in response to discrete location selection input 133 (e.g., selection of shape guide 351A), diagram editor 102 can update diagram data 112 (e.g., representing diagram 300) in compliance with layout constraints 106.

Automatic updating can include inserting the selected visual element into the arrangement of the plurality of visual elements at the selected corresponding discrete location (act 208). For example, diagram editor 102 can edit diagram data 112 to add element 305 to diagram data 112 (e.g., for diagram 300). Edits to diagram data 112 can indicate the selected corresponding discrete location in diagram 300 where element 305 is to be placed.

Automatic updating can also include an act of connecting the selected visual element to one or more other visual elements in the arrangement of the plurality of interconnected visual elements (act 209). For example, diagram editor 102 can edit diagram data 112 to add a connection from element 101 to element 305. The layout of the connection can comply with layout constraints 106 based on the locations of element 301 and element 305 within diagram 300.

If element 305 was an existing element in diagram 300, diagram editor 102 can also edit diagram data 112 to remove the prior location of element 305 and any corresponding connections (not represented in FIGS. 3A-3D) based on the prior location of element 305. Edits can be implemented to comply with layout constraints 106 based on the movement of element 305.

Diagram editor 102 can also edit diagram data 112 to re-arrange elements 302, 303, and 304 and their corresponding connections from element 301. Edits can be implemented to comply with layout constraints 106 based on the addition of element 305 to or movement of element 305 within diagram 300.

If element 305 was an existing element in diagram 300, diagram editor 102 can also edit other portions of diagram data 112 (not represented in FIGS. 3A-3D) to connect together one or more other elements that were previously connected to element 305. Edits can be implemented to comply with layout constraints 106 based on the movement of element 305.

Method 200 includes an act of presenting the updated arrangement of the plurality of interconnected visual elements in compliance with the constraints of the auto-layout algorithm so as to reflect the addition of the selected visual element to the diagram (act 210). For example, referring to FIGS. 1 and 3D, rendering module 107 can send updated visual elements 141U (e.g., elements 301, 302, 303, 304 and element 305 and corresponding connections as arranged in FIG. 3D) to display device 109. Display device 109 can present updated visual elements 141U in compliance with layout constraints 106 as enforced by auto-layout module 104. For example, as depicted in FIG. 3D, connection 311 connects element 301 to element 305. The arrangement of elements 302, 303 and 304 and corresponding connections is changed to accommodate connection 311 and element 305.

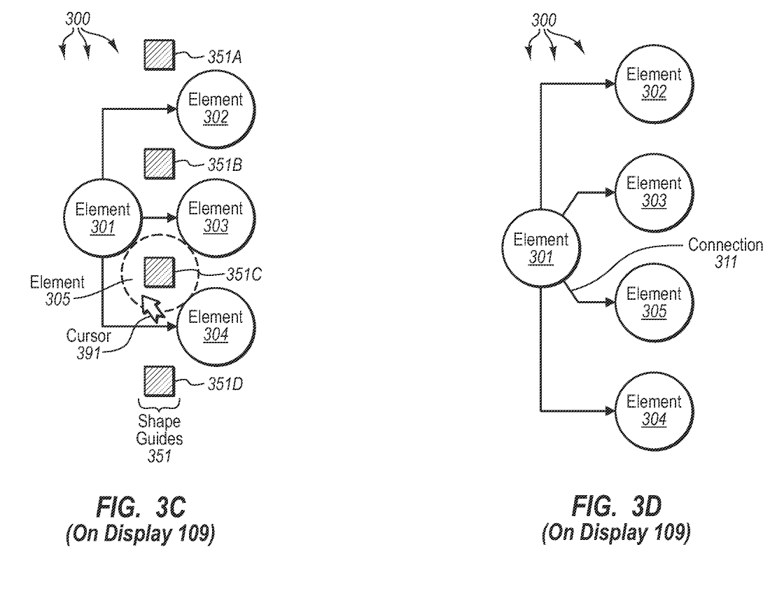

Accordingly, FIGS. 3A-3D illustrate an example of flexibly integrating a shape into an auto-layout compliant diagram. However, various other embodiments are also contemplated. Any of the previously and subsequently described diagrams can be displayed at and interacted with through the display (e.g., display 109) of a display device (e.g., display device 108). For example, FIGS. 4A-4C illustrate another example of flexibly integrating a shape into auto-layout compliant diagram 400.

As depicted in FIG. 4A, diagram 400 includes elements 401 and 402. Element 403 is currently selected and at least partially co-located with element 402. In response to the selection of element 403 and based on element 403 being at least partially co-located with element 402, shape guide 411 is presented. Shape guide 411 represents (although is not necessarily precisely at) a corresponding discrete location where element 403 can be placed for connection to element 402. Shape guide 411 is located based on the position of element 402 relative to element 401. Further, the corresponding discrete location corresponding to shape guide 411 complies with appropriate layout constraints (e.g., layout constraints 106).

As depicted in FIG. 4B, element 403 is subsequently moved (e.g., through user input) so that it is at least partially co-located with shape guide 411. While element 403 is at least partially co-located with shape guide 411, user-input can release (or activate) a mouse button (or other input control) to select the discrete location corresponding to shape guide 411 as the location for element 403. For example, using a mouse, a user can “drop” element 403 onto shape guide 411 to select the discrete location corresponding to shape guide 411.

In response to selection of shape guide 411 and as depicted in FIG. 4C, element 403 is connected to element 402 by connection 412. Upon connection between elements 402 and 403, appropriate diagram data can be edited to reflect the new location of element 403 (and remove its old location).

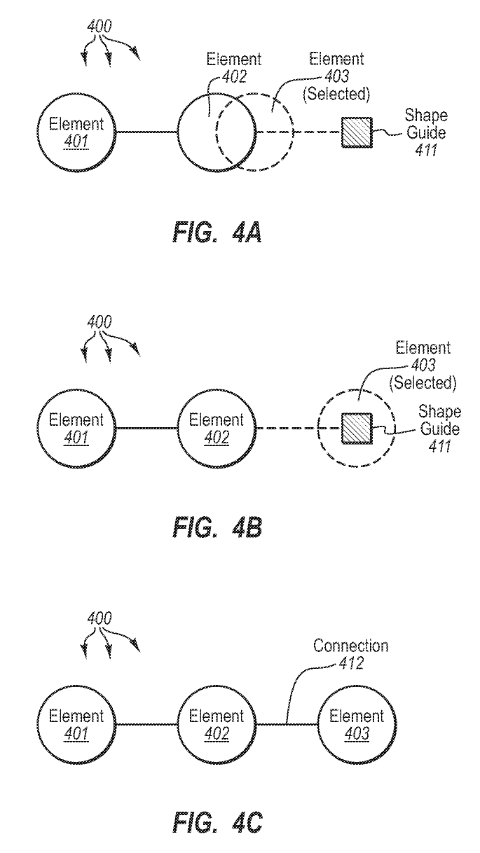

Embodiments of the present invention can also facilitate flexibly integrating a plurality of shapes into an auto-layout compliant diagram. For example, FIGS. 5A-5C illustrate an example of flexibly integrating a plurality of shapers into auto-layout compliant diagram 500.

As depicted in FIG. 5A, diagram 500 includes elements 501, 502, 503, and 504. A temporarily selected element 403 is currently selected and at least partially co-located with element 402. Element 503 and 504 remains at their current location. In response to the selection of element 403 and based on temporarily selected element 403 being at least partially co-located with element 402, shape guide 511 is presented. Shape guide 511 represents (although is not necessarily precisely at) a corresponding discrete location where element 503 can be placed for connection to element 502. Shape guide 511 is located based on the position of element 502 relative to element 501. Further, the corresponding discrete location corresponding to shape guide 511 complies with appropriate layout constraints (e.g., layout constraints 106).

As depicted in FIG. 5B, temporarily selected element 403 is subsequently moved (e.g., through user input) so that it is at least partially co-located with shape guide 511. While temporarily selected element 403 is at least partially co-located with shape guide 511, user-input can release (or activate) a mouse button (or other input control) to select the discrete location corresponding to shape guide 511 as the location for element 503. For example, using a mouse, a user can “drop” temporarily selected element 503 onto shape guide 511 to select the discrete location corresponding to shape guide 511.

In response to selection of shape guide 511 and as depicted in FIG. 5C, element 503 is connected to element 502 by connection 512. Further, the connection and relative position between elements 503 and 504 remains. Upon connection between elements 502 and 503, appropriate diagram data can be edited to reflect the new locations of each of elements 503 and 504 and their corresponding connection (and to remove their old locations and corresponding connection).

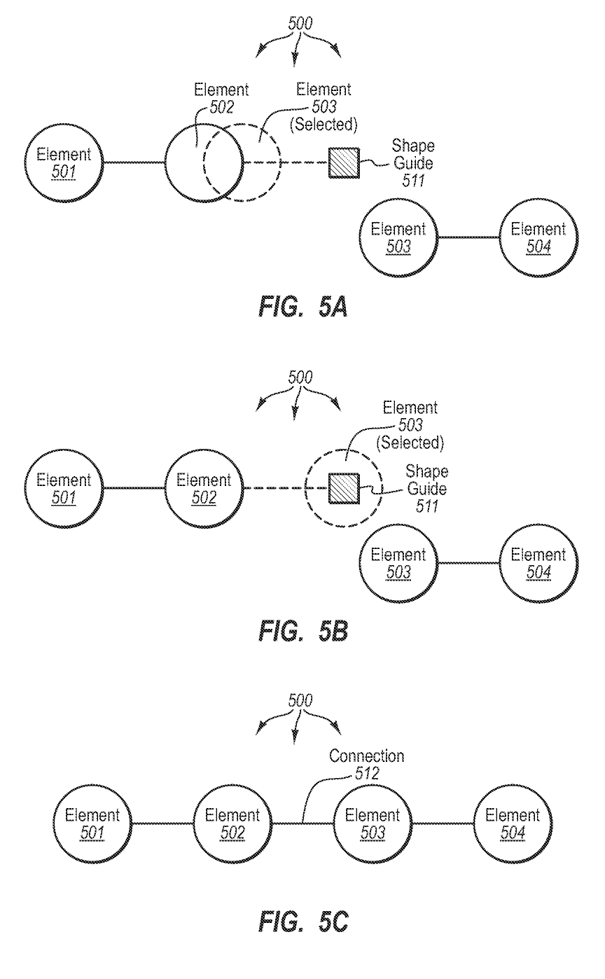

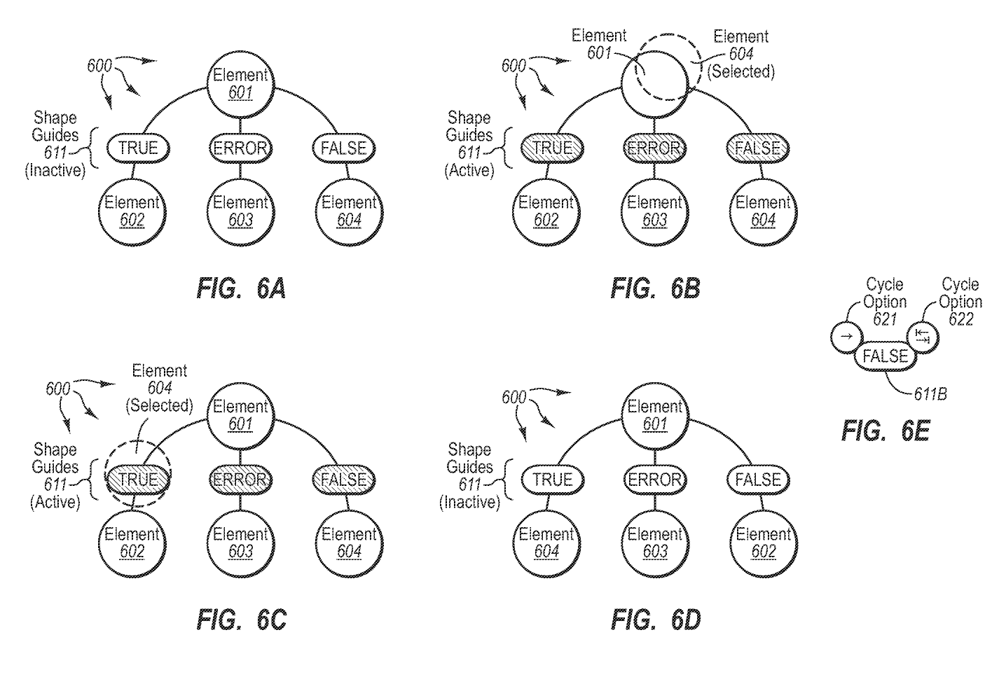

Embodiments of the present invention can also facilitate flexibly reordering shapes in an auto-layout compliant diagram. For example, FIGS. 6A-6C illustrate an example of flexibly reordering shapes in auto-layout compliant diagram 600.

As depicted in FIG. 6A, diagram 600 includes elements 601, 602, 603, and 604. Shape guides 611 provide meaning related to traversal from element 601 to one of elements 602, 603, and 604. For example, if a decision at 601 is TRUE, traversal to element 602 can occur. If a decision at 601 is FALSE, traversal to element 604 can occur. If a decision at 601 results in an ERROR, traversal to element 603 can occur. Shape guides 611 can be inactive, and thus primarily informational, when reordering is not progress.

As depicted in FIG. 6B, a temporarily selected element 603 is currently selected and at least partially co-located with element 601. Element 604 remains at its current location. In response to the selection of element 603 and based on temporarily selected element 603 being at least partially co-located with element 601, shape guides 611 are activated. Shape guides 611 represent the corresponding discrete locations for elements corresponding to TRUE, ERROR, and FALSE results at element 601 (and currently occupied by elements 602, 603 and 604 respectively).

As depicted in FIG. 6C, temporarily selected element 604 is subsequently moved (e.g., through user input) so that it is at least partially co-located with FALSE shape guide 611A. While temporarily selected element 604 is at least partially co-located with FALSE shape guide 61 1A, user-input can release (or activate) a mouse button (or other input control) to select the discrete location corresponding to FALSE shape guide 61 1A as the location for element 604. For example, using a mouse, a user can “drop” temporarily selected element 604 onto FALSE shape guide 611A to select the discrete location corresponding to FALSE shape guide 611A.

In response to selection of FALSE shape guide 611A and as depicted in FIG. 6D, the location of element 604 and the location of element 602 are swapped. Further, shape guides 611 are inactivated. Upon reordering, appropriate diagram data can be edited to reflect the new locations of each of elements 602 and 604 and their corresponding connections (and to remove their old locations and corresponding connections).

In some embodiments, shape guides have a single (default) behavior. However, in other embodiments, shape guides have a plurality of selectable behaviors. For example, FIG. 6E illustrates a shape guide 611B having a plurality of selectable behaviors. As depicted, shape guide 611B includes, cycle option 621 and swap option 622 (the default behavior of shape guide 611A). Shape guide 611B can replace shape guide 611A in diagram 600 to provide cycle option 621 and swap option 622 to a user.

Selecting swap option 622 in FIG. 6C would result in the depiction in FIG. 6D. On the other hand, selecting cycle option 621 in FIG. 6C would result in elements 604, 602, and 603 corresponding to TRUE, ERROR, and FALSE results at element 601 respectively. Upon reordering, appropriate diagram data can be edited to reflect the new locations of each of elements 602, 603, 604 and their corresponding connections (and to remove their old locations and corresponding connections).

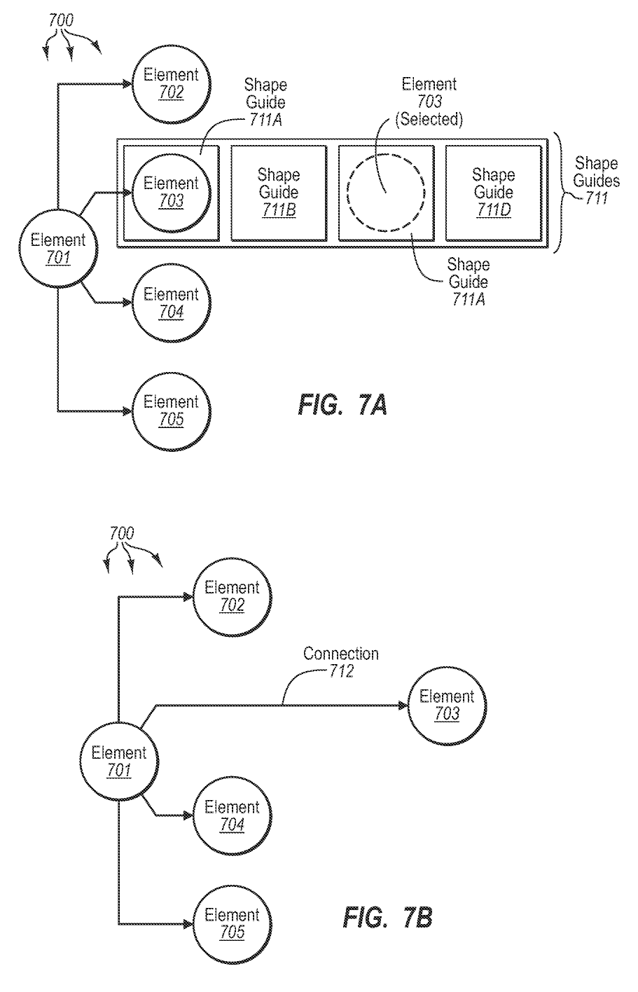

Embodiments of the present invention also permit shifting shapes in a diagram. Shifting permits a user to move a shape or plurality of shapes along a path (e.g., vertical or horizontal) based on the orientation of the parent shape. For example, FIGS. 7A and 7B illustrate shifting a shape within auto-layout compliant diagram 700.

As depicted in FIG. 7A, diagram 700 includes elements 701, 702, 703, 704, and 705. Shape guides 711 includes shape guides 711A, 711B, 711C, and 711D representing discrete locations for shifting element 703. A temporarily selected element 703 is currently selected and at least partially co-located shape guide 711C. Shape guide 711C represents (although is not necessarily precisely at) a corresponding discrete location where element 703 can be shifted for connection to element 701. Generally, shape guides 711 are located based on the position (e.g., orientation) of element 703 relative to element 701. Further, the corresponding discrete locations corresponding to shape guides 711 comply with appropriate layout constraints (e.g., layout constraints 106).

While temporarily selected element 703 is at least partially co-located with shape guide 711A, user-input can release (or activate) a mouse button (or other input control) to select the discrete location corresponding to shape guide 711A as the location for element 703. For example, using a mouse, a user can “drop” temporarily selected element 703 onto shape guide 711A to select the discrete location corresponding to shape guide 711A.

In response to selection of shape guide 511 and as depicted in FIG. 7B, element 703 is shifted horizontal further from element 701 and is connected to element 701 by connection 712. The connections and relative position between elements 701 and elements 70-2, 704, and 705 remains. Upon, (re)connection between elements 701 and 703, appropriate diagram data can be edited to reflect the new location element 703 and connection 712 (and to remove their old location and corresponding connection).

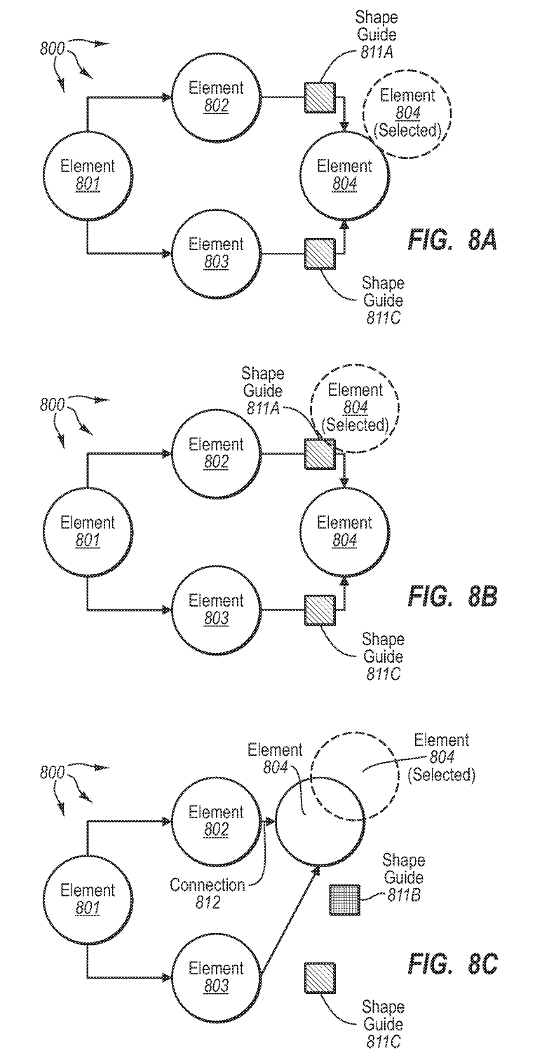

Embodiments of the present invention also permit snapping shapes into an out of defined patterns. For example, FIGS. 8A-8C illustrate snapping a shape within auto-layout compliant diagram 700.

As depicted in FIG. 8A, diagram 800 includes elements 801, 802, 803, and 804. Elements 801, 802, 803, and 804 are in a diamond pattern. A temporarily selected element 804 is currently selected. Element 804 remains at its current location. In response to the selection of element 804, shape guides 811A and 811C are presented. Shape guides 811A and 811C represent (although are not necessarily precisely at) corresponding discrete location where element 804 can be placed. Shape guides 811A and 811C are located based on the position of element 804 relative to elements 802 and 803. Further, the corresponding discrete locations corresponding to shape guides 811A and 811C comply with appropriate layout constraints (e.g., layout constraints 106).

As depicted in FIG. 8B, temporarily selected element 804 is subsequently moved (e.g., through user input) so that it is at least partially co-located with shape guide 811A. While temporarily selected element 804 is at least partially co-located with shape guide 811A, user-input can release (or activate) a mouse button (or other input control) to select the discrete location corresponding to shape guide 811A as the location for element 804. For example, using a mouse, a user can “drop” temporarily selected element 804 onto shape guide 811A to select the discrete location corresponding to shape guide 811A.

In response to selection of shape guide 811A and as depicted in FIG. 8C, element 802 is connected to element 804 by connection 812 and element 803 is connected to element 804 by connection 813. Upon connection between elements 802 and 804 and 803 and 804 appropriate diagram data can be edited to reflect the new location of element 804 and its corresponding connections (and to remove its old location and corresponding connections).

As further depicted in FIG. 8C, element 804 remains selected and at least partially overlapping with element 804. In response to the selection of element 804, shape guides 811B and 811C are presented. Shape guides 811B and 811C represent (although are not necessarily precisely at) corresponding discrete location where element 804 can be placed. Shape guides 811B and 811C are located based on the position of element 804 relative to elements 802 and 803. Further, the corresponding discrete locations corresponding to shape guides 811B and 811C comply with appropriate layout constraints (e.g., layout constraints 106). Shape guide 811B has a different visual characteristic than shape guide 811C. The different visual characteristic indicates that moving element 804 to the corresponding discrete location for shape guide 811C would cause the arrangement of elements 801, 802, 803mad 804 to again be in diamond pattern. Upon further connection of element 804, appropriate diagram data can again be edited to reflect the new location of element 804 and its corresponding connections (and to remove its old location and corresponding connections).

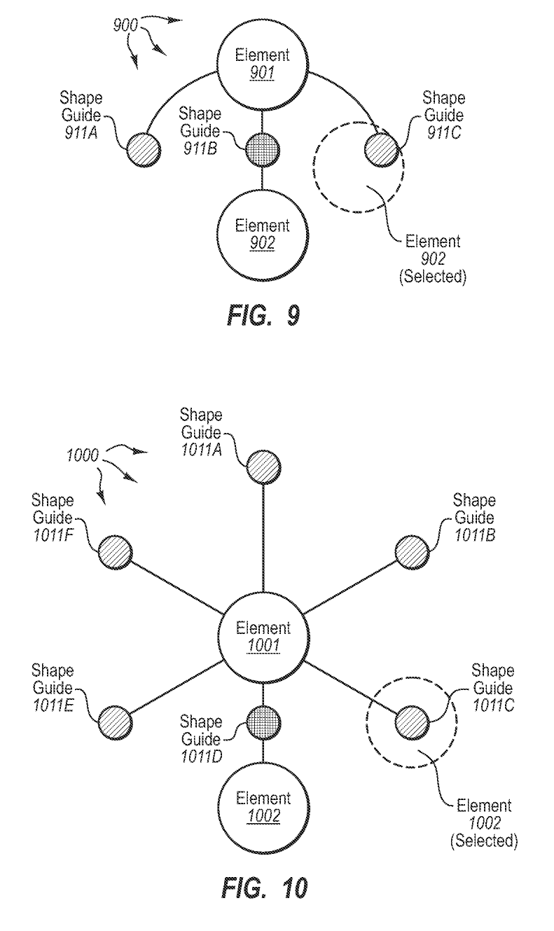

A variety patterns in addition to a diamond pattern are possible. For example, embodiments include a decision pattern. A decision pattern permits a user to decide which path a child element is to take. FIG. 9 illustrates shape guides for a decision pattern for an auto-layout compliant diagram 900.

As depicted in FIG. 9, diagram 900 includes elements 901 and 902. A temporarily selected element 902 is currently selected. Element 902 remains at its current location. In response to the selection of element 902, shape guides 911A, 9911B, and 911C are presented. Shape guides 911A, 911B, and 911C represent (although are not necessarily precisely at) corresponding discrete location where element 902 can be placed. Shape guides 911A, 911B, and 911C are located to indicate corresponding discrete locations for a decision tree. Further, the corresponding discrete locations corresponding to shape guides 911A, 911B, and 911C comply with appropriate layout constraints (e.g., layout constraints 106). Shape guides 911A and 911C can correspond to YES and NO, TRUE and FALSE, etc. respectively.

Shape guide 911B has different visual characteristic than shape guides 911A and 911C. The different visual characteristic can indicate that the corresponding discrete location for shape guide 911B is the current location of element 902. For example, shape guide 911B can correspond to an ERROR.

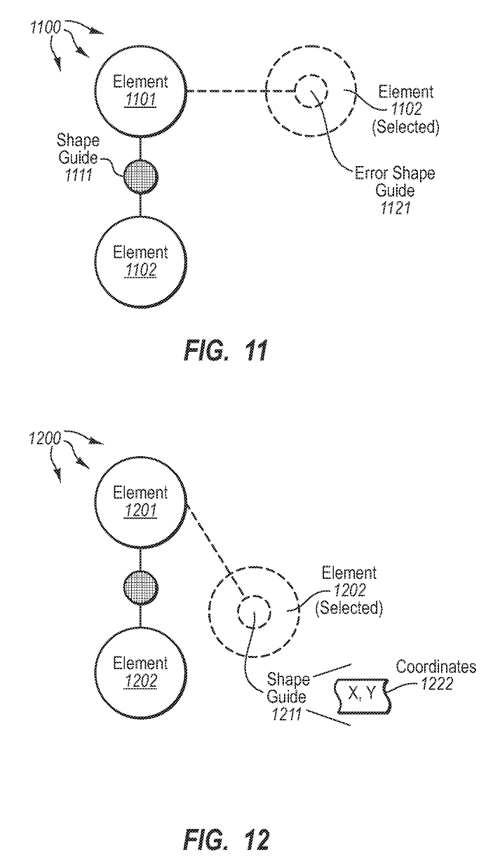

A radial pattern permits a user to move a shape to select a “spoke” where an element is to be located. FIG. 10 illustrates shape guides for a radial pattern for auto-layout compliant diagram 1000.

As depicted in FIG. 10, diagram 1000 includes elements 1001 and 1002. A temporarily selected element 1002 is currently selected. Element 1002 remains at its current location. In response to the selection of element 1002, shape guides 1011A-1011F are presented. Shape guides 1011A-1011F represent (although are not necessarily precisely at) corresponding discrete location where element 1002 can be placed. Shape guides 1011A-1011F are located to indicate corresponding discrete locations for radial pattern. Further, the corresponding discrete locations corresponding to shape guides 1011A-1011F comply with appropriate layout constraints (e.g., layout constraints 106). Shape guide 1011D has a different visual characteristic than the other shape guides. The different visual characteristic can indicate that the corresponding discrete location for shape guide 1011D is the current location of element 902.

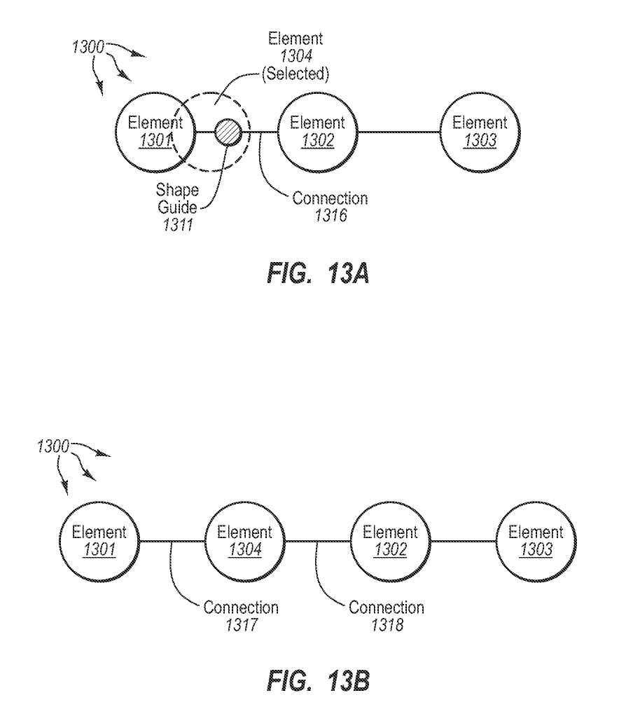

An error pattern permits a user to move a shape to a specified error path. An error pattern can included in diagrams that include the notion of an appropriate path and an error path, such as, for example, workflow and business process. In these environments, it may be desirable to adjust a shape from the appropriate path to the error path. FIG. 11 illustrates shape guides for an error for auto-layout compliant diagram 1100.

As depicted in FIG. 11, diagram 1100 includes elements 1101 and 1102. A temporarily selected element 1102 is currently selected. Element 1102 remains at its current location. In response to the selection of element 1102, shape guide 1111 and error shape guide 1121 are presented. Shape guide 1111 and error shape guide 1121 represent (although are not necessarily precisely at) corresponding discrete location where element 1102 can be placed. Further, the corresponding discrete locations corresponding to Shape guide 1111 and error shape guide 1121 comply with appropriate layout constraints (e.g., layout constraints 106). Error shape guide 1121 has a different visual characteristic than shape guide 1111. The different visual characteristic can indicate that error shape guide 1121 is a shape guide for an error path.

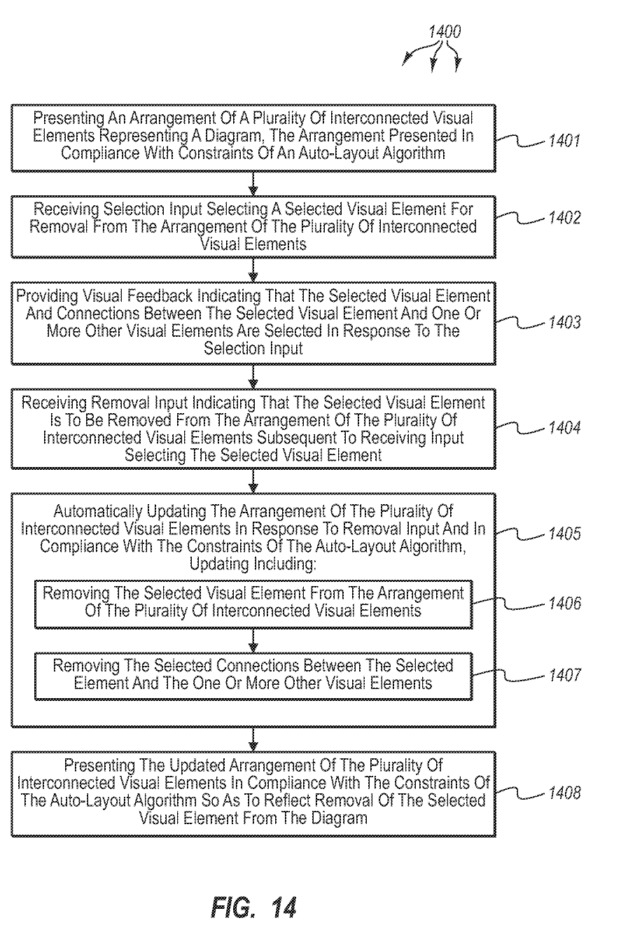

Non-compliance with auto-layout constraints can also be appropriate in some environments. Thus, embodiments of the invention permit a user to drop an element on a “freeform” shape guide. A freeform shape guide indicates to an auto-layout module to position a shape at specified (e.g., X, Y) coordinates rather than auto-layout positioning. FIG. 12 illustrates freeform shape guide for diagram 1200.

As depicted in FIG. 12, diagram 1200 includes elements 1201 and 1202. A temporarily selected element 1202 is currently selected. Element 1202 remains at its current location. In response to the selection of element 1202, freeform shape guide 1211 is presented. Freeform shape guide 1211 defines (although is not necessarily precisely at) X, Y coordinates 1222. X, Y coordinates 1222 represent a discrete location where element 1202 can be placed and that is not necessarily compliant with appropriate auto-layout constraints. Thus, auto-layout functionality can be overridden for placement of element 1202.

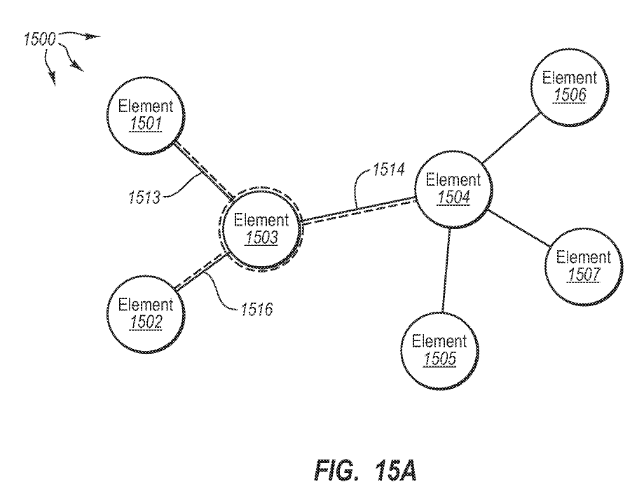

Embodiments of the present invention also include integrating a shape into a diagram between other shapes. For example, a user can drop a disconnected shape between two existing shapes. The existing connection is removed, the new shape is added at a corresponding discrete location, and two new connections are created. Thus, a user can restructure a potentially complicated subtree with a reduced number of user actions. FIGS. 13A and 13B illustrate an example of flexibly integrating a shape into an auto-layout compliant diagram 1300 between other existing shapes.

As depicted in FIG. 13A, diagram 1300 includes elements 1301, 1302, and 1303. Temporarily selected element 1304 has been moved through used input and is at least partially co-located with shape guide 1311. Shape guide 1311 is located based on the position of element 1301 relative to element 1302. Further, the corresponding discrete location corresponding to shape guide 1311 complies with appropriate layout constraints (e.g., layout constraints 106).

While temporarily selected element 1304 is at least partially co-located with shape guide 1311, user-input can release (or activate) a mouse button (or other input control) to select the discrete location corresponding to shape guide 1311 as the location for element 1304. For example, using a mouse, a user can “drop” temporarily selected element 1304 onto shape guide 1311 to select the discrete location corresponding to shape guide 1311.

In response to selection of shape guide 1311 and as depicted in FIG. 13B, connection 1316 removed. Connection 1317 connects elements 1301 and 1304 and connection 1318 connects elements 1304 and 1302. Upon connection between elements 1301 and 1304 and elements 1304 and 1302, appropriate diagram data can be edited to reflect the new location of element 1304 and connections 1317 and 1318 (and to remove its old location and corresponding connections and remove connection 1316).

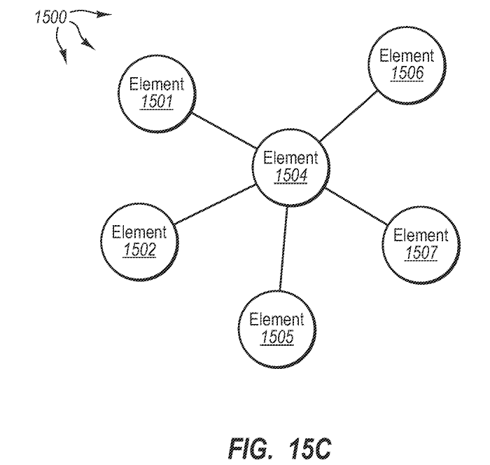

As previously described, embodiments of the invention can also facilitate removable of a shape form an auto-layout compliant diagram. FIGS. 15A-15C illustrate examples of flexibly removing a shape from auto-layout compliant diagram 1500.

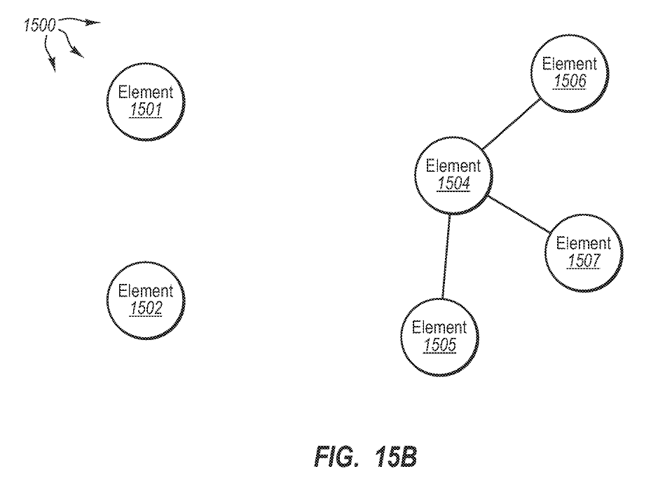

FIG. 14 illustrates a flow chart of an example method for flexibly removing a shape from an auto-layout compliant diagram. Method 1400 will be described with respect to the components and data depicted in computer architecture 100 and with respect to auto-layout compliant diagram 1500.

Method 1400 includes an act of presenting an arrangement of a plurality of interconnected visual elements representing a diagram, the arrangement presented in compliance with constraints of an auto-layout algorithm (act 1401). For example, rendering module 107 can present diagram 1500 on display 109. Method 1400 includes an act of receiving selection input selecting a selected visual element for removal form the arrangement of the plurality of interconnected visual elements. For example, referring to FIG. 15A, a user can enter user input selecting element 1502 for removal from diagram 1500. User-interface 101 can forward the user input to rendering module 107.

Method 1400 includes an act of providing visual feedback indicating that the selected visual element and connections between the selected visual element and one or more other visual elements are selected in response to the selection input (act 1403). For example, visual assist module 117 can provide visual feedback indicating that element 1503 and connections 1513, 1514, and 1516 are selected in response to user input selecting element 1503. Visual feedback can include changing the visual characteristics of the selected element and any appropriate connections. For example, in FIG. 15A, element 1503 and connections 1513, 1514, and 1516 are supplemented with a dashed line. However, other visual characteristics changes, such as, for example, changes to color, brightness, size, shape, etc. are also possible. Visual perception of the dashed line (or other visual characteristic) permits a user (e.g., user 113) to more easily determine that element 305 is selected.

Method 1400 includes an act of receiving removal input indicating that the selected visual element is to be removed from the arrangement of the plurality of interconnected visual elements subsequent to receiving input selecting the selected visual element (act 1404). For example, a user can enter user input to remove element 1503 from diagram 1503. User-interface 101 can forward the user input diagram editor 102.

Method 1400 includes an act of automatically updating the arrangement of the plurality of interconnected visual elements in response to removal input and in compliance with the constraints of the auto-layout algorithm (act 1405). For example, in response to removal input, diagram editor can update appropriate diagram data for diagram 1500 in compliance with layout constraints 106.

Automatic updating can include an act of removing the selected visual element from the arrangement of the plurality of interconnected visual elements (act 1406). For example, diagram editor 102 can edit the appropriate diagram data to remove element 1503 from diagram 1500. Automatic updating can also include an act of removing the selected connections between the selected element and the one or more other visual elements (act 1407). For example, diagram editor 102 can edit the appropriate diagram data to remove connections 1513, 1514, and 1516 from diagram 1500.

Method 1400 includes an act of presenting the updated arrangement of the plurality of interconnected visual elements in compliance with the constraints of the auto-layout algorithm so as to reflect removal of the selected visual element from the diagram (act 1408). For example, referring to FIG. 15B, rendering module 107 can present updated diagram 1500 on display 109. As depicted in FIG. 15B, element 1503 and connections 1513, 1514, and 1516 are removed.

In some embodiments, subsequent to removal of element 1503 and connections 1513, 1514, and 1516, elements 1501 and 1501 are re-connected to other elements in diagram 1500. Diagram editor 102, in compliance with layout constraints 106, can automatically edit appropriate diagram data to re-position elements 1501 and 105 and re-connect elements 1501 and 1502 to element 1504. For example, referring to FIG. 15C, connection 1517 connects element 1501 to element 1503 and connection 1518 connects element 1502 to element 1504. However, re-positioning relative to and re-connection to other elements is also possible.

Alternately, elements 1501 and/or 1502 can be left as orphans. A user can then select the elements and at least partially co-locate the temporary selected elements with another element to receive further visual feedback in the form of shape guides. The user can then select a shape guide to move the selected element and connect the selected element to another element.

Thus, embodiments of the invention facilitate adding, removing, and moving visual elements in a diagram. In some embodiments, moving an element is implemented using a combination of acts from methods 200 and 1400. That is, the element can be added to its new location in accordance with method 200 and removed from its current location in accordance with method 1400. Accordingly, embodiments of the invention provide a user experience that approaches the flexibility of free form editing but retains the benefits of auto-layout mechanisms.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. In a computer architecture, a method for flexibly integrating a shape into an auto-layout complaint diagram, the method comprising:
an act of presenting an arrangement of a plurality of interconnected visual elements representing a diagram, the arrangement presented in compliance with constraints of an auto-layout algorithm;
an act of receiving input selecting a selected visual element for placement in the arrangement of the plurality of interconnected visual elements;
an act of providing element selection visual feedback indicating that the selected visual element is selected;
an act of detecting the presence of the selected visual element at a location relative to the arrangement of the plurality of interconnected visual elements;
an act of providing discrete location visual feedback indicating a set of possible discrete locations where the selected visual element can be placed in the arrangement of the plurality of interconnected visual elements prior to placement of the selected visual element, each discrete location in the set of possible discrete locations complying with the constraints of the auto-layout algorithm, the visual feedback provided in response to selection of the selected visual element and based on detecting the presence of the selected visual element at the relative location;
an act of receiving input selecting a selected discrete location, from among the set of possible discrete locations, for placement of the selected visual element;
an act of automatically updating the arrangement of the plurality of interconnected visual elements in response to selection of the selected discrete location and in compliance with the constraints of the auto-layout algorithm, updating including:
an act of inserting the selected visual element into the arrangement of the plurality of visual elements at the selected discrete location; and
an act of connecting the selected visual element to one or more other visual elements in the arrangement of the plurality of interconnected visual elements; and
an act of presenting the updated arrangement of the plurality of interconnected visual elements in compliance with the constraints of the auto-layout algorithm so as to reflect the addition of the selected visual element to the diagram.

2. The method as recited in claim 1, wherein the act of presenting an arrangement of a plurality of interconnected visual elements representing a diagram comprises an act of presenting an arrangement of interconnected geometric shapes.

3. The method as recited in claim 1, wherein the act of receiving input selecting a selected visual element for placement in the arrangement of the plurality of interconnected visual elements comprises an act of receiving input selecting a visual element that is to be moved from a current location in the arrangement of the plurality of interconnected visual elements to the selected discrete location.

4. The method as recited in claim 3, wherein an act of automatically updating the arrangement of the plurality of interconnected visual elements in response to selection of the selected discrete location and in compliance with the constraints of the auto-layout algorithm further includes:
an act of removing the selected visual element from its current location in the arrangement of the plurality of interconnected visual elements; and
an act of removing the selected connections between the selected element and the one or more other visual elements in the arrangement of the plurality of interconnected visual elements.

5. The method as recited in claim 4, wherein the act of automatically updating the arrangement of the plurality of interconnected visual elements in response to selection of the selected discrete location and in compliance with the constraints of the auto-layout algorithm further includes:
an act of repositioning the one or more other visual elements for compliance with the auto-layout algorithm; and
an act of reconnecting the one or more other visual elements to the arrangement of the plurality of interconnected visual elements.

6. The method as recited in claim 1, wherein the act of providing element selection visual feedback indicating that the selected visual element is selected comprises an act of altering the visual characteristics of the selected element.

7. The method as recited in claim 1, wherein the act of detecting the presence of the selected visual element at a location relative to the arrangement of the plurality of interconnected visual elements comprises an act of detecting that the selected element is as at least partially co-located with another element in the diagram.

8. The method as recited in claim 1, wherein the act of providing discrete location visual feedback indicating a set of possible discrete locations where the selected visual element can be placed comprises an act of visually presenting one or more shape guides corresponding to auto-layout compliant locations where the selected element can be placed.

9. The method as recited in claim 8, wherein the act of visually presenting one or more shape guides corresponding to auto-layout compliant locations where the selected element can be placed comprises an act of visually presenting one or shape guides each having a plurality of selectable behaviors, each selectable behavior configured to implement an different alteration to the arrangement of the plurality of interconnected visual elements in response to placement of the selected element at a corresponding auto-layout compliant location.

10. The method as recited in claim 8, wherein the act of visually presenting one or more shape guides corresponding to auto-layout compliant locations where the selected element can be placed comprises an act of visually presenting shape guides for placing the arrangement of the interconnected plurality of visual elements in a diamond pattern.

11. The method as recited in claim 8, wherein the act of visually presenting one or more shape guides corresponding to auto-layout compliant locations where the selected element can be placed comprises an act of visually presenting shape guides for placing the arrangement of the interconnected plurality of visual elements in a radial pattern.

12. The method as recited in claim 8, wherein the act of visually presenting one or more shape guides corresponding to auto-layout compliant locations where the selected element can be placed comprises an act of visually presenting shape guides for placing the arrangement of the interconnected plurality of visual elements in an error pattern.

13. The method as recited in claim 8, wherein the act of visually presenting one or more shape guides corresponding to auto-layout compliant locations where the selected element can be placed comprises an act of visually presenting shape guides for placing the arrangement of the interconnected plurality of visual elements in a decision pattern.

14. The method as recited in claim 8, wherein the act of visually presenting one or more shape guides corresponding to auto-layout compliant locations where the selected element can be placed comprises an act of visually presenting shape guides for shifting the selected visual element either horizontally or vertically.

15. The method as recited in claim 8, wherein the act of visually presenting one or more shape guides corresponding to auto-layout compliant locations where the selected element can be placed comprises an act of visually presenting a shape guide on a connection between two other elements in the diagram.

16. The method as recited in claim 1, wherein the act of providing discrete location visual feedback indicating a set of possible discrete locations where the selected visual element can be placed comprises an act of visually presenting a shape guide corresponding to location expressly defined by a set of coordinates to override the auto-layout algorithm

17. In a computer architecture, a method for flexibly removing a shape from an auto-layout complaint diagram, the method comprising:
an act of presenting an arrangement of a plurality of interconnected visual elements representing a diagram, the arrangement presented in compliance with constraints of an auto-layout algorithm;
an act of receiving selection input selecting a selected visual element for removal form the arrangement of the plurality of interconnected visual elements;
an act of providing visual feedback indicating that the selected visual element and connections between the selected visual element and one or more other visual elements are selected in response to the selection input;
an act of receiving removal input indicating that the selected visual element is to be removed from the arrangement of the plurality of interconnected visual elements subsequent to receiving input selecting the selected visual element;
an act of automatically updating the arrangement of the plurality of interconnected visual elements in response to the removal input and in compliance with the constraints of the auto-layout algorithm, updating including:
an act of removing the selected visual element from the arrangement of the plurality of interconnected visual elements;
an act of removing the selected connections between the selected element and the one or more other visual elements;
an act of presenting the updated arrangement of the plurality of interconnected visual elements in compliance with the constraints of the auto-layout algorithm so as to reflect removal of the selected visual element from the diagram.

18. The method as recited in claim 17, wherein the act of automatically updating the arrangement of the plurality of interconnected visual elements in response to the removal input and in compliance with the constraints of the auto-layout algorithm, further includes:
an act of repositioning the one or more other visual elements for compliance with the auto-layout algorithm.

19. The method as recited in claim 17, wherein the act of automatically updating the arrangement of the plurality of interconnected visual elements in response to the removal input and in compliance with the constraints of the auto-layout algorithm, further includes:
an act of reconnecting the one or more other visual elements to the arrangement of the plurality of interconnected visual elements.

20. A computer system, the computer system comprising:
one or more processors;
system memory; and
one or more computer-readable media have stored thereon computer-executable instructions representing a diagram editor, an auto-layout module, a rendering module, and a visual assist module, the rendering module configured to:
present arrangements of pluralities of interconnected visual elements representing diagrams, the arrangements presented in compliance with constraints of an auto-layout algorithm enforced by the auto-layout module; and
present updated arrangements of the pluralities of interconnected visual elements in compliance with the constraints of the auto-layout algorithm so as to reflect the addition, removal, or movement of visual elements in the represented diagrams;
wherein the diagram editor is configured to:
automatically update the arrangements of a plurality of interconnected visual elements in response to addition, removal, or movement of visual elements in represent diagrams and in accordance with the constraints of the auto-layout algorithm, including:
inserting a selected visual element into an arrangement of a plurality of visual elements at a selected discrete location;
connecting a selected visual element to one or more other visual elements in an arrangement of an plurality of interconnected visual elements;
removing a selected visual element from an arrangement of a plurality of interconnected visual elements; and
removing selected connections between a selected element and one or more other visual elements in an arrangement of an plurality of interconnected visual elements; and
wherein the visual assist module is configured to:
provide inclusion selection visual feedback indicating that a selected visual element is selected inclusion at a location in a diagram;
provide discrete location visual feedback indicating a set of possible discrete locations where a selected visual element can be placed in the arrangement of the plurality of interconnected visual elements prior to placement of the selected visual element, each discrete location in the set of possible discrete locations complying with the constraints of the auto-layout algorithm, the visual feedback provided in response to selection of the selected visual element and based on detecting the presence of the selected visual element at location relative to another visual element in a diagram; and
provide removal selection visual feedback indicating that a selected visual element and connections between the selected visual element and one or more other visual elements are selected for removal from a diagram.
